(19) United States
(12) Patent Application Publication
(10) Pub. No.: US 2026/0167145 A1
(43) Pub. Date: Jun. 18, 2026

(54) VEHICLE THEFT PREVENTION SYSTEM

(71) Applicant: John Paul Detlor, Bowmanville (CA)

(72) Inventor: John Paul Detlor, Bowmanville (CA)

(21) Appl. No.: 18/978,668

(22) Filed: Dec. 12, 2024

(51) Int. Cl. B60R 25/01; B60N 2/02; B60N 2/04; B60N 2/20; B60R 25/24

(52) U.S. Cl. CPC B60R 25/014; B60N 2/02246; B60N 2/04; B60N 2/20; B60R 25/24

(57) ABSTRACT

A vehicle anti-theft system that is operably coupled with the driver's seat of a vehicle wherein the system is configured to move the driver's seat from a first position to a second position in order to prevent operation of the vehicle. The system includes a seat control module wherein the seat control module is operably coupled to the seat motor controlling the movement of the driver's seat. In the first mode, the seat control module permits the first position of the driver's seat allowing occupancy thereof. In the second mode, the seat control module moves the driver's seat such that the base portion is forward and the seat back is placed in an angular position against the steering wheel of the vehicle. The system can be operably integrated into the key fob of the vehicle, be operated with an independent transmitter or be manually operated with an interface.

### FIELD OF THE INVENTION

The present invention relates generally to vehicle theft prevention, more specifically but not by way of limitation, an anti-theft system integrated into operational functional elements of the vehicle so as to prevent operation of the vehicle. By way of example but not limitation, the present invention operably couples with the seat operational motors and door lock system via a wireless transmitter so as to place the driver seat of the vehicle into a position inhibiting operation of the vehicle.

### BACKGROUND

From 2019 to 2023, in the United States, the nationwide rate of motor vehicle theft incidents rose from 199.4 incidents per 100,000 people to 283.5 incidents. From 2022 to 2023, incident rates declined in the Midwest by 4.8 and the West by 7.3. The rate of offenses committed by juveniles increased in 2022 and 2023, while the rate of offenses committed by adults decreased during that time. In addition, between 2022 and 2023, the rate of reported carjacking incidents declined from 7.5 to 6.6 per 100,000 people. The top three types of motor vehicles stolen from 2019 to 2023 were automobiles at 78.1 percent, trucks at 12.2 percent, and other motor vehicles at 8.0 percent. Drivers in the United States reported over a million motor vehicles stolen in 2023, according to the National Insurance Crime Bureau. That's roughly the same theft rate as 2022, but part of an ongoing spike in auto theft since 2019.

In 2023, 1,020,729 vehicles were reported stolen, up from 1,008,756 in 2022. California remains the state with the most vehicles stolen in 2023(208,668 ), but Colorado has the highest theft rate. Maryland and the District of Columbia saw the biggest percent increase in thefts from 2022 to 2023. Theft claim frequency for 2003-2023 Hyundai and Kia models was almost 7 times higher than for all other makes in the first six months of 2023. The average claim severity for stolen cars other than Hyundai and Kia models was $21,681 in the first half of 2023. Motor vehicle theft is the third most common property crime in the United States. Car theft is increasingly common in the U.S. In 2023, 1,020,729 vehicles were stolen, compared to 1,008,756 in 2022 and 794,019 in 2019, according to the National Insurance Crime Bureau, representing an increase of 28.5 percent in just four years.

Canada's auto theft crisis is showing no signs of slowing down, according to new data released by Insurance Bureau of Canada. In 2023, the cost of insurance claims for replacing stolen vehicles in Canada skyrocketed to a record-breaking $1.5 billion. This marks the second year in a row auto theft claims costs have topped $1 billion. To put this into perspective, between 2018 and 2021, auto theft claims costs averaged $556 million annually. These numbers indicate that the auto theft crisis persists, disrupting the lives of Canadians and causing them concern and trauma. Between 2018 and 2023, auto theft claims costs have increased significantly across the country. Nationally, auto theft claims costs increased by 254%. In 2023, auto theft losses amounted to over $1.5 billion, an increase of nearly 20% from 2022 (the year that held the previous record). The previous four-year national average, between 2018 and 2021, was $556 million. The crisis is most significant in Ontario, where auto theft claims costs increased by 524% between 2018 and 2023, surpassing $1 billion for the first time in 2023.

Common methods and apparatus exist for assisting in vehicle theft prevention. A locked home garage is one of the greatest theft deterrents, but locking your car when you're not in it, parking in well-lit areas and keeping your key fob with you can help prevent theft. Locks for steering wheels, hoods and wheels to secure vehicles when not in use. GPS trackers are another available tool to assist in vehicle theft prevention. While the aforementioned does prevent some vehicle thefts, additional prevention systems are needed based on the aforementioned data.

Accordingly, there is a need for an anti-theft system for vehicles that is integrally connected with operational components of the vehicle that prevent operation of the vehicle once placed in the second mode of the system of the present invention.

### SUMMARY OF THE INVENTION

It is the object of the present invention to provide an anti-theft system for a vehicle that is operably coupled to various elements of the vehicle wherein the present invention is placed in a first mode and a second mode utilizing a wireless transmitter.

Another object of the present invention is to provide a system for vehicles that is configured to prevent the theft thereof wherein the present invention includes a controller that is operably coupled to the seat motors controlling the movement of the driver seat of the vehicle.

A further object of the present invention is to provide an anti-theft system for a vehicle that is operably coupled to various elements of the vehicle wherein in the first mode of the present invention the driver seat of the present invention is positioned to permit operation of the vehicle.

Yet a further object of the present invention is to provide a system for vehicles that is configured to prevent the theft thereof wherein in the second mode of the present invention the driver seat of the vehicle is moved to a position that inhibits operation of the vehicle.

Still another object of the present invention is to provide an anti-theft system for a vehicle that is operably coupled to various elements of the vehicle wherein the present invention is further operably coupled to a satellite communication module of the vehicle.

An additional object of the present invention is to provide a system for vehicles that is configured to prevent the theft thereof wherein the present invention is further configured to provide operational communication to law enforcement agencies.

Yet a further object of the present invention is to provide an anti-theft system for a vehicle that is operably coupled to various elements of the vehicle wherein the present invention includes a seat control module present in the driver's seat of the vehicle providing the operational interface for the first mode and second mode of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of an exemplary driver seat in the first mode of the present invention; and

FIG. 2 is a diagrammatic view of an exemplary driver seat in the second mode of the present invention.

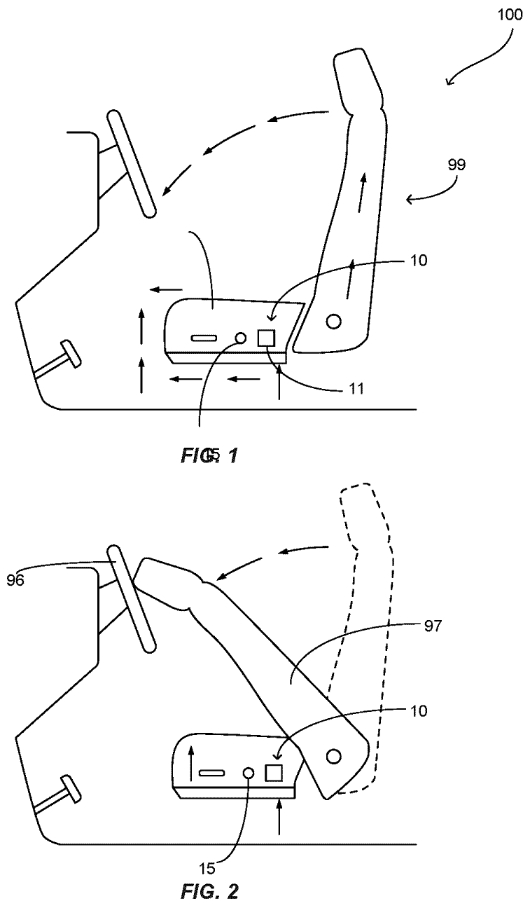

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle anti-theft system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the vehicle anti-theft system 100 is operably integrated with the driver seat 99 of a vehicle. As will be discussed herein, the present invention functions to place the driver seat 99 in a first mode and a second mode. In the first mode of the present invention that driver seat 99 is in a position that permits occupancy thereof in order allow operation of the vehicle. The second mode of the present invention places the driver seat in such a position that the occupancy thereof is not physically possible and as such inhibits operation of the vehicle.

The vehicle anti-theft system 100 includes a seat control module 10. The seat control module 10 includes the necessary electronics to receive, store, transmit and manipulate data signals. The seat control module 10 includes housing 11 and is mounted in the base portion 98 of the driver seat 99. It should be understood within the scope of the present invention that the seat control module 10 could be mounted in numerous alternate locations. The seat control module 10 is operably coupled to the seat control motor 15. The seat control motor 15 provides operational control of the driver seat 99. By way of example but not limitation, the seat control motor 15 provides backwards-forwards of the base portion 98. Additionally, the seat control motor 15 provides operational control of the seat back 97, specifically the tiltable movement thereof. It should be understood within the scope of the present invention that the seat control module 10 can be configured to be communicably coupled with the conventional key fob that is provided with most conventional vehicles. In operation, when the key fob is utilized to lock the doors of the vehicle in which the vehicle anti-theft system 100 is installed, the seat control module 10 will place the driver seat 99 in the second mode. As is illustrated herein in FIG. 2, in the second mode, the driver seat 99 has the base portion 98 moved as far forward as possible and further places the seat back 97 at an inclined position such that a portion of the seat back 97 is adjacent to an engaging the steering wheel 96. The seat control module 10 provides electronic control of the seat control motor 15 so as to maintain the driver seat 99 in the second position until a signal from the key fob is received wherein the signal provides unlocking of the vehicle doors which further activates the seat control module 10 to place the driver seat 99 into the first position. In the first position of the driver seat 99, the seat back 97 is reclined to a normal operating position and the operator of the vehicle can move the base portion 98 with the seat control motor 15. It should be understood within the scope of the present invention that the seat control module 10 could be operated with the key fob of the vehicle and further be provided with an interface control panel that would facilitate the operation thereof.

It is further contemplated within the scope of the present invention that the vehicle anti-theft system 100 can be communicably coupled to a satellite communication module of the vehicle if present. As is known in the art, many vehicles are equipped with satellite communication modules that are employed to communicably couple the operator of the vehicle with emergency assistance. This can include communications such as but not limited to roadside assistance and emergency assistance wherein the latter can be delivered automatically subsequent the detection of a vehicle crash or airbag deployment. These conventional systems include an interface button that allows a user to contact a monitoring company in the event of an emergency wherein automatic communication has not been initiated. The vehicle anti-theft system 100 is operably coupled to the satellite communication system present in a vehicle. It is contemplated within the scope of the present invention that the vehicle anti-theft system 100 would activate the driver seat 99 into the second position in the event of an occurrence such as but not limited to a car-jacking. By way of example but not limitation, an operator of a vehicle would depress an emergency button on the satellite communication module and notification would be transmitted to a monitoring agency as well as law enforcement agencies. This could be executed in events such as but not limited to a car-jacking. Additional events could be triggered such as but not limited to locking of the vehicle.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle anti-theft system operably coupled to a driver's seat within a vehicle wherein the vehicle anti-theft system comprises:
a seat control module, said seat control module having a housing, said housing having disposed therein electronics configured to receive, store, manipulate and transmit data, said seat control module being operably coupled to a seat motor, said seat motor configured to provide movement of a base portion of the driver's seat and a seat back of the driver's seat, said seat control module configured to place the driver's seat in a first mode and a second mode; and
wherein in said first mode, the driver's seat is in a position allowing occupancy thereof for vehicle operation.

2. The vehicle anti-theft system operably coupled to the driver's seat of a vehicle as recited in claim 1, wherein in said second mode the base portion of the driver's seat is moved forward.

3. The vehicle anti-theft system operably coupled to the driver's seat of a vehicle as recited in claim 2, wherein in said second mode, the seat back of the driver's seat is placed in an angular orientation such that a portion thereof is adjacent to a steering wheel if the vehicle.

4. The vehicle anti-theft system operably coupled to the driver's seat of a vehicle as recited in claim 3, wherein in said second mode, the driver's seat is in a position that inhibits occupancy thereof.

5. The vehicle anti-theft system operably coupled to the driver's seat of a vehicle as recited in claim 4, wherein the vehicle anti-theft system is operably coupled to a satellite communications module within the vehicle.

6. The vehicle anti-theft system operably coupled to the driver's seat of a vehicle as recited in claim 5, wherein the vehicle anti-theft system is operably coupled to a key fob wherein the key fob is configured to provide operation of door locks on the vehicle.
